(19) United States
(12) Patent Application Publication
(10) Pub. No.: US 2009/0066985 A1
(43) Pub. Date: Mar. 12, 2009

(54) Email pay-for-print system

(76) Inventor: Andrew Rodney Ferlitsch, Carnas, WA (US)

Correspondence Address: SHARP LABORATORIES OF AMERICA, INC., 1320 PEARL ST., SUITE 228, BOULDER, CO, 80302, US

(21) Appl. No.: 11/899,579

(22) Filed: Sep. 6, 2007

(51) Int. Cl. G06F 3/12; H04Q 7/20

(52) U.S. Cl. 358/1.13; 358/1.15; 455/406; 455/466

(57) ABSTRACT

Email pay-for-print system that affords users greater flexibility and transparency in billing. In one aspect, the invention comprises at least one mobile computing node, at least one printing node and a server node communicatively coupled with the mobile computing node and the printing node, wherein the server node receives via email a print job from the mobile computing node, transmits to the mobile computing node in response to the print job an email quotation for the print job comprising price information determined based at least in part on a cost analysis of the print job and, after receiving from the mobile computing node an acceptance of the quotation, transmits the print job to the printing node for outputting.

### BACKGROUND OF THE INVENTION

The present invention relates to print services for mobile computing nodes and, more particularly, an email pay-for-print system that affords users greater flexibility and transparency in billing.

Increasing reliance on mobile computing nodes, such as notebook computers, personal data assistants (PDAs) and cell phones, has spurred demand for email print services. Email print services enable roaming users to initiate print jobs from email clients commonly installed on mobile computing nodes. Such services thus permit roaming users to obtain hard copies of documents, photographs, etc. without the need to install cumbersome print applications or printer drivers on their mobile computing nodes and without the need to connect to the networks that host the printing nodes.

Unfortunately, known email print services have significant shortcomings in the areas of billing flexibility and transparency. Because email print services are often invoked by roaming users who do not own the printing resources being consumed, such services often charge users of such services, that is, the services are provided on a pay-for-print basis. However, email pay-for-print services are not known to advise a user what a print job will cost before starting the print job and allow the user to accept or decline; or provide a user adequate flexibility in choosing a billing method.

### SUMMARY OF THE INVENTION

The present invention provides an email pay-for-print system that affords users greater flexibility and transparency in billing.

In one aspect, the invention provides an email print system having at least one mobile computing node, at least one printing node and a server node communicatively coupled with the mobile computing node and the printing node, wherein the server node receives an email print job from the mobile computing node, transmits to the mobile computing node in response to the print job an email quotation for the print job comprising price information determined based at least in part on a cost analysis of the print job and, after receiving from the mobile computing node an acceptance of the quotation, transmits the print job to the printing node for outputting.

In some embodiments, the quotation further comprises billing information determined based at least in part on a user of the mobile computing node.

In some embodiments, the quotation further comprises a fillable element for receiving billing information from a user of the mobile computing node.

In some embodiments, the price information is determined based at least in part on an analysis of print settings associated with the print job.

In some embodiments, the price information is determined based at least in part on an analysis of individual drawing objects associated with the print job.

In some embodiments, the price information is determined based at least in part on an estimate by the server node of consumable resources required by the print job.

In some embodiments, the price information is determined based at least in part on an estimate generated by the server node of mechanical operations required by the print job.

In some embodiments, the server node verifies billing information associated with the acceptance before transmitting the print job to the printing node for outputting.

In some embodiments, the server node monitors the printing node while the printing node is outputting the print job and facilitates charging of a user of the mobile computing node upon completion of the print job.

In some embodiments, the acceptance comprises first billing information and the server node transmits to the mobile computing node a request for second billing information after a failed attempt to verify the first billing information.

In another aspect, the invention provides a server node having at least one network interface, a memory, and a processor communicatively coupled with the network interface and the memory, wherein the processor receives from a mobile computing node via the network interface an email print job and transmits via the network interface to the mobile computing node in response to the print job an email quotation for the print job comprising price information determined by the processor based at least in part on a cost analysis of the print job and, after receiving from the mobile computing node via the network interface an acceptance of the quotation, transmits to a printing node via the network interface the print job for outputting.

In yet another aspect, the invention provides an email pay-for-print method, comprising the steps of receiving via email from a mobile computing node a print job, identifying a printing node for outputting the print job, converting the print job into a format compatible with the printing node, determining a price for the print job based on a cost analysis of the print job, transmitting to the mobile computing node via email a quotation for the print job including the price, receiving from the mobile computing node an acceptance of the quotation including billing information, verifying the billing information and transmitting the print job to a printing node for outputting.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows an email pay-for-print system in which the invention is operative in some embodiments.

FIG. 2 shows the email server node of FIG. 1 in more detail.

FIG. 3 shows an email pay-for-print method in some embodiments of the invention.

FIG. 4 shows message flows within the email pay-for-print system.

FIG. 5 shows functional elements of the email server node of FIG. 1.

### DETAILED DESCRIPTION OF A PREFERRED EMBODIMENT

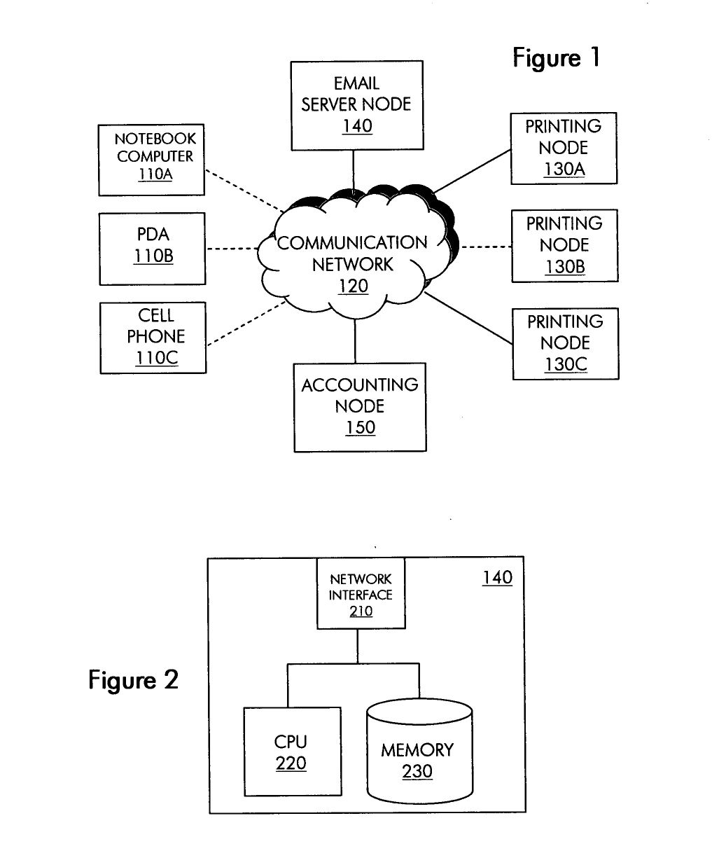

FIG. 1 shows an email pay-for-print system in which the invention is operative in some embodiments. The system includes multiple mobile computing nodes 110, including a notebook computer 110A, a PDA 110B and a cell phone 110C, and multiple printing nodes 130 communicatively coupled with an email server node 140 over a communication network 120. Naturally, while three each of mobile computing nodes 110 and printing nodes 130 are shown, a system within the scope of the invention may have a different number of mobile computing nodes and/or printing nodes. Moreover, while in the embodiments described herein the system is a printing system, the invention is applicable to other imaging systems, such as scanning, copying and faxing systems, wherein the imaging nodes are scanning nodes, copying nodes and faxing nodes, respectively, and is also applicable to hybrid imaging systems having multiple types of imaging nodes.

Mobile computing nodes 110 are data communication devices that have email client software for transmitting to email server node 140, via email messages, print jobs and receiving from email server node 140, via email messages, quotations for print jobs. Print jobs are initiated by transmitting them to email server node 140 via wireless network interfaces of mobile computing nodes 110, such as wireless local area network (LAN), wide area network (WAN) or cellular network interfaces. Print jobs are preprocessed by email server node 140, which identifies destination printing nodes for outputting print jobs, converts print jobs into a printing node (PN)-ready format compatible with destination printing nodes, generates quotations for print jobs and, in conjunction with accounting server node 150, verifies billing information and commits charges for print jobs. Mobile computing nodes 110 may also have Web browser software, such as Microsoft Internet Explorer®, installed thereon for communicating with email server node 140 and viewing HTML, eXtensible HTML (XHTML), Cascading Style Sheets (CSS), Javascript, Scalable Vector Graphics (SVG) and other web formatted documents received from email server node 140.

Communication network 120 is a data communication network that may include one or more wired or wireless LANs, WANs, WiMax networks and/or ad-hoc networks each of which may have one or more data communication nodes, such as switches, routers, bridges and/or hubs, operative to communicatively couple mobile computing nodes 110 and printing nodes 130 via email server node 140. In some embodiments, communication network 120 traverses the Internet.

Printing nodes 130 are printing devices having respective wired or wireless network interfaces, such as a LAN or WAN interfaces, that communicatively couple printing nodes 130 to communication network 120. Printing nodes 130 are capable of receiving via their respective network interfaces print jobs in a PN-ready format, processing the print jobs and outputting the print jobs. In some embodiments, printing nodes 130 are multifunction printing (MFP) nodes that provide multiple types of imaging services, such as scanning, copying and faxing. Internal to each printing node 130A, 130B, 130C, a processor (CPU), a memory, a network interface, a print engine and, in some embodiments, a scan, copy and/or fax engine are communicatively coupled. The CPU receives print jobs in a PN-ready format from the memory where they are temporarily stored and performs output processing on the print jobs, including raster image processing (RIP), to convert the print jobs from the PN-ready format into a raster format which is passed to the print engine for outputting in hard copy format. The print engine includes printer logic, such as one or more printer integrated circuits (IC), and a mechanical section, such as a color ink jet head mounted on a movable carriage, for outputting the raster data in hard copy format under control of the one or more printer ICs.

FIG. 2 shows email server node 140 in more detail. Email server node 140 is a data communication device that preprocesses email print jobs initiated by mobile computing nodes 110 and received on a network interface 210 of email server node 140, which may be a wired or wireless LAN or WAN interface, for example. Preprocessing includes identifying destination printing nodes for outputting print jobs, converting print jobs into a PN-ready format, generating quotations for print jobs including prices based on an analysis of elements of the print job and, in conjunction with accounting server node 150, verifying billing information and committing charges for print jobs. Preprocessing is performed using software executed by a CPU 220 resident on email server node 140 in conjunction with selection data stored in memory 230, which may consist of one or more random access memories (RAMs) and one or more read only memories (ROM).

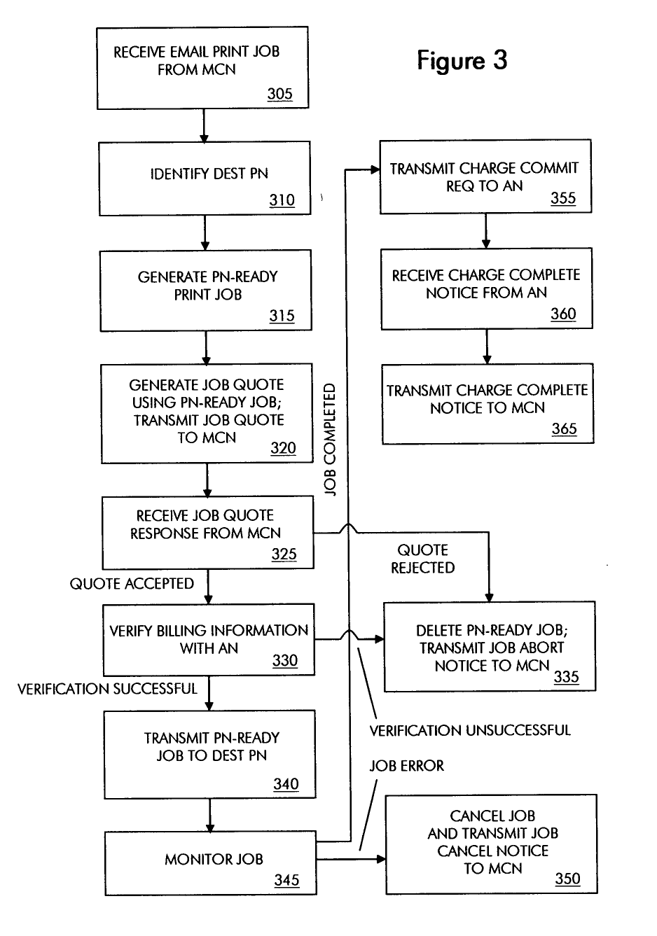

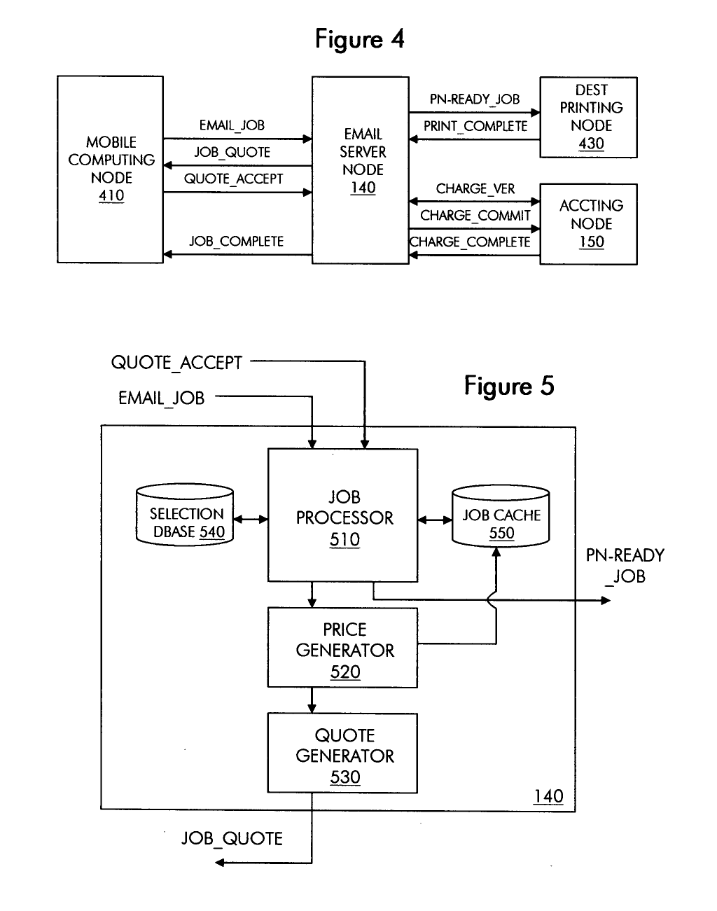

FIG. 3 shows an email pay-for-print method in some embodiments of the invention. The method is realized through message flows shown in FIG. 4 in which email server node 140 intermediates between a mobile computing node 410, a destination printing node 430 and accounting node 150 and in which substantial processing is performed by functional elements of email server node 140 shown in FIG. 5. In the message flows, mobile computing node 410, which is representative of mobile computing nodes 110, and email server node 140 communicate using email messages and, in some embodiments, also communicate using Hypertext Transfer Protocol (HTTP) messages wherein mobile computing node 410 may receive input from a user of mobile computing node 410 and transmit output to the user of mobile computing node 410 via a Web browser. Email server node 140 communicates with destination printing node 430, which is representative of printing nodes 130, and with accounting node 150, using TCP/IP-based flows.

In the illustrated method, email server node 140 first receives from mobile computing node 410 an email print job (EMAIL_JOB) (305). The email print job is an email message including print job data and, in some embodiments, information sufficient to identify destination printing node 430 and print settings. The email message further has information sufficient to identify the user of mobile computing node 410, such as a source email address, a username or a user account number. Destination printing node 430 may be identified by the destination email address or a destination network address, network name, other printer-friendly name or printing node characteristics included in the subject line or body of the email message, for example. Print settings may be specified in the body of the email message, for example. In some embodiments, the identity of destination printing node 430 and/or print settings may be omitted from the email message, in which case email server node 140 may identify destination printing node 430 and/or determine print settings by resorting to selection database 540. The print job data are included as an attachment to the email message, such as an attached Microsoft Word® document or Portable Document Format (PDF) document, for example.

In response to the email print job, email server node 140 generates an email job quotation (JOB_QUOTE). Turning to FIG. 5, functional elements of email server node 140 involved in generating the job quotation are shown to include job processor 510, price generator 520 and quote generator 530, which are software modules that execute on CPU 220, and which access selection database 540 and job cache 550 in performing their respective functions. Selection database 540 and job cache 550 are data stores within memory 230. Naturally, email server node 140 may have other software modules and data stores that may be invoked, for example, to perform user authentication and accounting operations within the email pay-for-print system.

More particularly, upon receipt of an email print job, job processor 510 first either identifies destination printing node 430 from the email message, or selects destination printing node 430 by resort to selection database 540 (310).

Next, job processor 410 converts, if necessary, the print job into a PN-ready format compatible with destination printing node 430 (315). For example, the attachment having the print job data may be in a format native to destination printing node 430, in which case the attachment is already PN-ready and does not require conversion; on the other hand, the attachment may arrive in a format non-native to destination printing node 430, in which case the attachment requires conversion. Conversion may be performed using software operative on or accessible to job processor 510, such as a print application that supports the format of the attachment (e.g. Microsoft Word® print application) coupled with a printer driver for destination printing node 430; or a print application that supports the format of the attachment coupled with a generic printer driver and a printer-specific filter for destination printing node 430; or a transcoder; or an external translation service, for example. In any event, conversion is done in conformance with print settings specified in the body of the email print job message, and if none are specified, then in conformance with default print settings that are associated with an entity involved in the transaction, such as destination printing node 430, email server node 140, mobile computing node 410 or the user of mobile computing node 410. The default print settings may be retrieved by job processor 510 from selection database 440. Once conversion is completed, job processor 510 caches in job cache 550 the print job in a PN-ready format.

Next, price generator 520 and quote generator 530 are invoked to generate an email job quotation, which is transmitted to mobile computing node 410 (320). Price generator 520 is first invoked to determine a price for the print job based on a cost analysis. The price may be based on an estimate of consumable resources required for the print job, for example, the amount and type of paper, the amount and type of ink, the amount and type of connectors (e.g. staples, paper clips, etc.) and the amount of electrical power that will be consumed. The price may also account for other factors, such as amortization, the time of day, and mechanical operations, such as punching, folding, cutting and stacking. Additionally, the price may include a profit margin, which may be built into resource pricing or separately added. Price generator 520 may arrive at a price based on an analysis of elements of the print job, such as print settings and/or individual drawing objects within the PN-ready data. For example, the price may be may be determined based on the number of images, impressions or sheets in the print job, whether the print job is a color or black-and-white print job and whether the print job is in high or low color, for example. In some embodiments, price generator 520 may apply heuristic rules to individual text, vector and bitmap drawing objects of the print job to estimate the amount of various types of ink consumed by the individual drawing objects, and then sum those estimates to estimate the amount of various types of ink consumed by the print job.

Quote generator 530 is then invoked to generate a job quotation including the price information. The quotation is an email message including a form for viewing on mobile computing node 410. The form may be a native email form or HTML form embedded in the email message, for example. The form identifies the destination printing node 430, print settings and a price for the print job. The form also includes one or more user input elements, such as action buttons, through which a user of mobile computing node 410 can accept or decline the quotation through user input. The form may also include default billing information and one or more fillable elements into which a user of mobile computing node 410 may enter alternative billing information. The default and alternative billing information may include bank, debit card, credit card or prepaid account numbers, for example. Job processor 510 may reference selection database 540 using user information from the email print job to determine the default billing information. Once ready, the email quotation is transmitted to mobile computing node 410.

In some embodiments, while email server node 140 is processing the email print job and preparing the email quotation, job processor 510 transmits to mobile computing node 410 periodic or event-driven job status notifications.

Email server node 140 eventually receives from mobile computing node 410 a response to the job quotation, which may be an acceptance (QUOTE_ACCEPT) or a rejection (325). An acceptance may be an email message or an HTTP message, for example, and may include alternative billing information input by the user of mobile computing node 410. If alternative billing information is not provided in an acceptance, the user the print job is charged according to the default billing information that was included in the email job quotation, assuming the default billing information can be successfully verified.

In other embodiments, the job quotation may be transmitted in a text message that does not include a form through which a user of mobile computing node 410 can accept or decline the quotation through user input. In some of these embodiments, a user of mobile computing node 410 accepts the job quotation by replying to the text message within a predetermined time, and implicitly rejects the job by failing to reply within the predetermined time. In other embodiments, a user of mobile computing node 410 accepts the job quotation by including a keyword, such as “ACCEPT”, in a reply to the text message, and declines the job quotation by including a keyword, such as “DECLINE,” in a reply to the text message.

If the user rejects the job quotation, either explicitly or by failing to respond within a predetermined time, email server node 140 deletes the print job from job cache 550 and transmits to mobile computing node 410 an email notification that the print job has been aborted (335).

In response to an acceptance, email server node 140 attempts to verify with accounting server 150 the default or alternative billing information indicated in the acceptance (330). Email server node 140 exchanges messages (CHARGE_VER) with accounting node 150 to attempt to verify the billing information. For example, email server node 140 transmits to accounting node 150 a charge verification request including the billing information and a charge amount commensurate with the price for the print job, in response to which accounting node 150 inquires whether the billing information is associated with an active account having sufficient funds to pay the charge amount and transmits to email server node 140 a charge verification response including the results of the inquiry.

If the verification response indicates a failure to verify, that is, if the billing information is deficient, in some embodiments email server node 140 deletes the print job from job cache 550 and transmits to mobile computing node 410 a notification indicating that the job has been aborted (335). In other embodiments, email server node 140 transmits to mobile computing node 410 via an email message a second chance form for viewing on mobile computing node 410. The second chance form may be a native email form or HTML form embedded in the email message. The second chance form advises the user of mobile computing node 410 of the inability to verify the billing information in the original acceptance and requests corrected billing information. The second chance form may include default billing information and one or more fillable elements in which a user of mobile computing node 410 may enter billing information. The corrected billing information may be a bank, debit card, credit card or prepaid account number, for example. Once the user has provided corrected billing information, which may be default billing information or may be alternative billing information entered into the fillable elements, a second chance acceptance message is transmitted to email server node 140 and the charge verification process is repeated.

If the verification response indicates successful verification, that is, if the billing information is not deficient, email server node 140 extracts the print job in a PN-ready format (PN-READY_JOB) from job cache 550 and transmits the print job to destination printing node 430 (340), whereupon destination printing node 430 begins outputting the print job.

While the print job is being output on destination printing node 430, email server node 140 monitors status of the print job through message exchanges with destination printing node 430 (345). Monitoring may be accomplished by polling, bidirectional synchronous event notifications, or unidirectional asynchronous notifications, for example. If email server node 140 detects a print job error, in some embodiments email server node 140 cancels the print job and transmits to mobile computing node 410 an email notification that the print job has been cancelled (350).

In other embodiments, email server node 140 first determines if the print job error is correctable and, if so, transmits to mobile computing node 410 an email notification instructing the user as to corrective action and giving the user the option to take such action. In still other embodiments, email server node 140 first determines if the error is correctable and, if so, transmits to an administrator (with a copy to mobile computing node 410) an email notification instructing the administrator in and giving the administrator the option to take corrective action. In these embodiments, the print job is resumed if the user or administrator takes corrective action in a predetermined time. On the other hand, email server node 140 cancels the print job and transmits to mobile computing node 410 a notification that the print job has been cancelled if the user or administrator opts to cancel the print job or fails to take corrective action within a predetermined time.

If email server node 140 does not detect a print job error through monitoring, the print job completes in due course and email server node 140 transmits to accounting server 150 a request to charge the user based on the earlier-verified billing information (CHARGE_COMMIT) (355). In response to the charge request, accounting server 150 commits the charge and transmits to email server node 140 a notification that the charge has been committed (CHARGE_COMPLETE) (360), upon which email server node 140 transmits to mobile computing node 410 a notification that the print job has been completed and charged (JOB COMPLETE) (365).

In some embodiments, whenever a print job requires output of multiple output sets (e.g. multiple copies), email server node 140 monitors how many output sets of the print job have been output. Then, in the event the print job is cancelled prior to completion, email server node 140 issues a partial charge request to accounting server 150 in an amount commensurate with the number of output sets that were output before the error occurred.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. An email print system, comprising:
at least one mobile computing node;
at least one printing node; and
a server node communicatively coupled with the mobile computing node and the printing node, wherein the server node receives via email a print job from the mobile computing node, transmits to the mobile computing node in response to the print job an email quotation for the print job comprising price information determined based at least in part on a cost analysis of the print job and, after receiving from the mobile computing node an acceptance of the quotation, transmits the print job to the printing node for outputting.

2. The system of claim 1, wherein the quotation further comprises billing information determined based at least in part on a user of the mobile computing node.

3. The system of claim 1, wherein the quotation further comprises a fillable element for receiving billing information from a user of the mobile computing node.

4. The system of claim 1, wherein the price information is determined based at least in part on an analysis of print settings associated with the print job.

5. The system of claim 1, wherein the price information is determined based at least in part on an analysis of individual drawing objects associated with the print job.

6. The system of claim 1, wherein the server node verifies billing information associated with the acceptance before transmitting the print job to the printing node for outputting.

7. The system of claim 1, wherein the server node monitors the printing node while the printing node is outputting the print job and facilitates charging of a user of the mobile computing node upon completion of the print job.

8. A server node, comprising:
at least one network interface;
a memory; and
a processor communicatively coupled with the network interface and the memory, wherein the processor receives from a mobile computing node via the network interface an email print job and transmits via the network interface to the mobile computing node in response to the print job an email quotation for the print job comprising price information determined by the processor based at least in part on a cost analysis of the print job and, after receiving from the mobile computing node via the network interface an acceptance of the quotation, transmits to a printing node via the network interface the print job for outputting.

9. The server node of claim 8, wherein the quotation further comprises billing information determined based at least in part on a user of the mobile computing node.

10. The server node of claim 8, wherein the quotation further comprises a fillable element for receiving billing information from a user of the mobile computing node.

11. The server node of claim 8, wherein the price information is determined based at least in part on an analysis of print settings associated with the print job.

12. The server node of claim 8, wherein the price information is determined based at least in part on an analysis of individual drawing objects associated with the print job.

13. The server node of claim 8, wherein the price information is determined based at least in part on an estimate generated by the server node of consumable resources required by the print job.

14. The server node of claim 8, wherein the price information is determined based at least in part on an estimate generated by the server node of mechanical operations required by the print job.

15. The server node of claim 8, wherein the server node verifies billing information associated with the quotation before transmitting the print job to the printing node for outputting.

16. The server node of claim 8, wherein the server node monitors the printing node while the printing node is outputting the print job and facilitates charging of a user of the mobile computing node upon completion of the print job.

17. The server node of claim 8, wherein the acceptance comprises first billing information and wherein the server node transmits to the mobile computing node a request for second billing information after a failed attempt to verify the first billing information.

18. An email pay-for-print method, comprising the steps of:
receiving via email from a mobile computing node a print job;
identifying a printing node for outputting the print job;
converting the print job into a format compatible with the printing node;
determining a price for the print job based on a cost analysis of the print job;
transmitting to the mobile computing node via email a quotation for the print job including the price;
receiving from the mobile computing node an acceptance of the quotation including billing information;
verifying the billing information; and
transmitting the print job to a printing node for outputting.

19. The method of claim 18, wherein the quotation comprises a form including the price and default billing information associated with a user of the mobile computing node and a fillable element for receiving alternative billing information from the user.

20. The method of claim 18, further comprising monitoring the printing node while the printing node is outputting the print job and charging of a user of the mobile computing node upon completion of the print job.
